(19) United States
(12) Patent Application Publication
(10) Pub. No.: US 2009/0294372 A1
(43) Pub. Date: Dec. 3, 2009

(54) INHIBITION OF WATER FORMED SCALE IN ACID CONDITIONS

(76) Inventors: Jasbir S. Gill, Naperville, IL (US); Daniel N.T. Hay, Naperville, IL (US)

Correspondence Address: NALCO COMPANY, 1601 W. DIEHL ROAD, NAPERVILLE, IL, 60563-1198, US

(21) Appl. No.: 12/130,515

(22) Filed: May 30, 2008

(51) Int. Cl. C02F 5/08

(52) U.S. Cl. 210/697; 210/699

(57) ABSTRACT

The current invention relates to the inhibition of scale deposits in an acidic slurry or solution. The current invention uses an aqueous synthetic mixture comprising a phosphate, phosphonate, anionic polymer, or combinations thereof in the slurry and/or solution to inhibit scale during the processing of ore. The production of scale in an acidic environment is difficult because of the acidic solution neutralizing most known inhibitors. The claimed invention has a significant decrease in the scale production allowing for reduced down time of systems for de-scaling procedures.

### COPYRIGHT NOTICE

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

This invention relates to the inhibition of deposit (fouling) containing scales such as calcium sulfate, calcium fluosilicate, etc. from acidic aqueous solutions by addition of synthetic aqueous mixtures containing organic phosphonates, organic phosphate derivatives, inorganic phosphates, anionic polymers and copolymers, or a combination thereof.

### BACKGROUND

Phosphoric acid is generally produced from a crude phosphate containing ore that has been upgraded or beneficiated by washing, desliming, and flotation. The beneficiated material is then ground prior to digestion in sulfuric acid. Typically, to a slurry of beneficiated rock and recycled acid from the process, concentrated sulfuric acid is added at a rate to control the exotherm in a quantity ranging from 100 to 105% of the stoichiometric amount based on a calcium oxide calculation. After digestion is completed the digested phosphate rock is then subjected to a filtration and evaporation step and subsequent clarification steps to produce finished phosphoric acid which is then converted into products ranging from fertilizer to detergent additives, animal feeds, phosphorous containing products used in the phosphatizing of steel, or any other purified phosphoric acid products.

One of the most bothersome problems in the digestion of phosphate rock and in the evaporation of phosphoric acid is the precipitation of solids. The precipitation occurs primarily in the evaporators and equipment associated therewith. A certain amount occurs also on other surfaces of the process including the digesters and the filtration systems. Scale formation is most troublesome when highly concentrated acid is produced. Particularly troublesome is scaling of heat exchanger surfaces. Most attempts to correct this problem have been directed to equipment design but even the best-designed equipment is not capable of preventing scale formation.

Due to the high concentrations of calcium sulfate produced by the process, calcium sulfate is thought to be the primary ingredient of the scales caused from the digestion of phosphate rock. It is also believed that there are different forms of calcium sulfate responsible for scale deposition. These forms, Gypsum (CaSO₄.2H₂O), calcium sulfate Hemihydrate (CaSO₄.½H₂O), and calcium sulfate Anhydrite (CaSO₄) are dependent on temperature and the residence time in the evaporators. This phase transformation adds to the complexity of their inhibition. Additional important ingredients of these scales are fluosilicate salts, and/or other materials depending on the composition of the ore and specific process conditions. It is the prevention of these mixed scales that makes it is possible to inhibit and substantially prevent scale formation occasioned in the production of phosphoric acid.

The manufacture of phosphates and phosphoric acid is further detailed in the work by Becker, “Phosphates and Phosphoric Acid,” copyright 1989 by Marcel Dekker, Inc. and Slack, “Phosphoric Acid, Part I and Part II,” copyright 1968 by Marcel Dekker, Inc.

There is no reference in the literature, which suggest any satisfactory solution of inhibiting the precipitation and prevention of deposition on the surfaces associated with evaporators including heat exchangers. The solution was to shut down the operation and either mechanically or chemically clean the deposit.

The present invention is predicated upon the discovery that certain water-soluble organic and inorganic phosphates, phosphonates, polycarboxylates and their homopolymers or copolymers, and their mixtures are able to inhibit both formation and adherence of deposit causing minerals.

The current invention is a method of preventing scale/deposit from forming on surfaces in contact with digested phosphate rock and/or phosphoric acid produced from the digestion, which comprises treating the digested phosphate rock, the acid slurry and/or the acid stream produced by the digestion of phosphate rock throughout the acid production process with a scale inhibiting compound or their formulations at substoichiometric amounts. The preferred application point is in the acid stream directly prior to it entering the evaporator(s) and while in the evaporator(s). Inhibitors are typically added within a dosage range of 0.1-5000 ppm, preferably 0.1-100 ppm and most preferably 0. 1-50 ppm.

Generally, the wet process production of phosphoric acid involves the digestion of a phosphate containing ore slurry with sulfuric acid. The resulting phosphoric acid is separated from precipitated calcium sulfate and other solid impurities by filtration. The phosphoric acid solution is then concentrated through evaporation and clarified to yield the finished phosphoric acid (˜50-70% P₂O₅). Although much of the calcium sulfate and other impurities are removed during the filtration step, a significant amount remains dissolved in the process stream after filtration. As the phosphoric acid is concentrated through the evaporator circuit, calcium sulfate of various forms continues to precipitate from solution resulting in scale deposition on high temperature surfaces due to the inverse relationship between calcium sulfate(s) solubility and temperature. This and other deposits negatively impact heat transfer to the process stream as well as restrict liquor flow. Consequently, the scale must be removed through periodic cleanouts. Thus, the scaling phenomenon causes significant loss of process efficiency and results in added cost.

The addition of scale inhibitors to aqueous acidic simulated process solutions resulted in the reduction of deposited scale by up to 95-97% compared to an equivalent untreated solution.

### Inorganic Phosphate:

Is comprised of a compound containing the phosphate moiety or phosphate units linked by phosphoanhydride bonds.

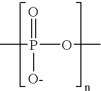

where n≧1

### Organic Phosphate:

Comprised of an ester of inorganic phosphate.

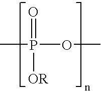

where R is alkyl or aryl and n≧1

### Phosphonate:

Comprised of a compound containing the structural moiety.

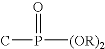

where R is H, alkyl, or aryl

### Polycarboxylate:

Comprised of a polymer derived from monomers containing the carboxylic acid functional group or salts thereof selected, for example, from the group consisting of acrylic acid, methacrylic acid, α-haloacrylic acid, maleic acid or anhydride, vinylacetic acid, allylacetic acid, fumaric acid, and β-carboxyethylacrylate. Polycarboxylate copolymers can also incorporate, along with carboxy containing monomers, monomers containing the sulfonic acid group or salts thereof selected, for example, from the group consisting of 2-acrylamido-2-methylpropylsulfonic acid, 2-methacrylamido-2-methylpropylsulfonic acid, vinylsulfonic acid, sulfoalkyl acrylate, sulfoalkyl methacrylate, allylsulfonic acid, methallylsulfonic acid, and 3-methacrylamido-2-hydroxypropylsulfonic acid.

### Homopolymer:

Comprised of a polymer derived from only one monomeric species.

### Copolymer:

Comprised of a polymer derived from two or more monomeric species (heteropolymer).

### SUMMARY

The current invention describes the following key aspects:
1. It is an advantage of the invention to provide the reduction of scale build up in acid conditions.
2. It is an advantage of the invention to inhibit scale formation within various sections of the process in which it is used, thus allowing for flexibility of use.
3. It is an advantage of the invention to provide increased operating time between required cleanouts.
4. It is an advantage of the invention to provide a method for uninterrupted production.

### DETAILED DESCRIPTION

The claimed invention is a process for inhibiting the formation of scale in acid production wherein an ore is combined with an acidic solution in a digestion process to form an acidic slurry which is passed through a filtration process to form an acidic stream where a scale inhibiting composition is added to the acidic stream at any point in the acid production. The process has the flexability that the scale inhibiting composition can be additionally added during digestion and/or to the acidic slurry and/or prior to the processing of the acidic slurry and is added in substoichiometric amounts. The preferred ore for use in the process is a phosphate containing ore.

The preferred scale inhibiting composition contains a phosphorous component and is added to the acidic slurry from 0.1 to 5000 ppm and preferably at 0.1 to 100 ppm and most preferably at 0.1 to 50 ppm. The scale inhibiting composition may be one or a combination of an organic phosphate, a phosphonate, an inorganic phosphate, a polycarboxylate homopolymer or copolymer.

The current invention additionally relates to a process for inhibiting the formation of scale in an acid production wherein a phosphate containing ore is combined with an acidic solution for digestion and forms an acidic slurry where a scale inhibiting composition can be added to the acidic slurry solution prior to its filtration. The scale inhibiting composition can be additionally added during digestion. The phosphate containing ore can be beneficiated prior to being combined with the acidic solution. The acidic solution can be sulfuric acid. The scale inhibiting composition can be one or a combination of an organic phosphate, a phosphonate, an inorganic phosphate, a polycarboxylate homopolymer or copolymer.

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims

### EXAMPLES

The foregoing may be better understood by reference to the following examples, which are intended to illustrate methods for carrying out the invention and are not intended to limit the scope of the invention.

A synthetic aqueous solution was prepared by dissolving an appropriate amount of calcium chloride and sodium sulfate in deionized water. The pH of the solution was adjusted to 2 using reagent grade phosphoric acid and maintained while deionized water was added to yield the desired final volume of 500 mL. When inhibitor was used, it was added to this synthetic solution prior to dilution to the final volume. The resulting test solution was transferred to a baffled vessel then heated with stirring at 85° C. for 1.5 or 2 hours in order to promote the formation of solid calcium sulfate.

The weight of scale deposited onto a submerged independently heated stainless steel test coupon was recorded. The surface area of the stainless steel coupon was equivalent within each test set. The percent inhibition was determined by comparing the weight of scale deposited from an inhibitor treated solution to the weight from an equivalent untreated solution, where the tests were both conducted under the same experimental conditions.

TABLE 1

| | Inhibitor A | | | | |
|---|---|---|---|---|---|
| | 0 ppm | 15 ppm | 20 ppm | 30 ppm | 60 ppm |
| Scale Mass (mg): | 81.0 | 18.2 | 12.1 | 11.1 | 4.5 |

| | | | | |
|---|---|---|---|---|
| % Inhibition: | 77.5 | 85.1 | 86.2 | 94.4 |

Table 1: Scale Mass (mg) Observed Over a Range of Scale Inhibitor A Dosages (Actives, ppm) Using a Synthetic Aqueous Solution. Solution Conditions: Ca²⁺: 1000 ppm, SO₄²⁻: 8000 ppm, pH: 2 (H₃PO₄).

TABLE 2

| | | Inhibitor A | Inhibitor B |
|---|---|---|---|
| | 0 ppm | 0.5 ppm | 0.5 ppm |
| Scale Mass (mg): | 104.9 | 33.9 | 29.4 |

| | | |
|---|---|---|
| % Inhibition: | 67.7 | 72.0 |

Table 2: Scale Mass (mg) Observed at Equivalent Scale Inhibitor Dosages (Actives, ppm) Using a Synthetic Aqueous Solution. Solution Conditions: Ca²⁺: 1400 ppm, SO₄²⁻: 3360 ppm, pH: 2 (H₃PO₄).

TABLE 3

| | | Inhibitor A | | | Inhibitor B | | |
|---|---|---|---|---|---|---|---|
| | 0 ppm | 1.2 ppm | 2.7 ppm | 5.8 ppm | 0.75 ppm | 1.7 ppm | 3.7 ppm |
| Scale Mass (mg): | 89.2 | 11.2 | 2.9 | 2.7 | 23.1 | 5.0 | 4.6 |

| | | | | | | |
|---|---|---|---|---|---|---|
| % Inhibition: | 87.4 | 96.8 | 97.0 | 74.1 | 94.4 | 94.8 |

Table 3. Scale Mass (mg) Observed Over a Range of Scale Inhibitor Dosages (Actives, ppm) Using a Synthetic Aqueous Solution. Solution Conditions: Ca²⁺: 1400 ppm, SO₄²⁻: 3360 ppm, pH: 2 (H₃PO₄).

Inhibitor A: mixture of inorganic phosphates

Inhibitor B: mixture of phosphonate and polycarboxylate copolymer

We claim:

1. A process for inhibiting the formation of scale in acid production wherein an ore is combined with an acidic solution in a digestion process to react forming an acidic slurry which is passed through a filtration process to form an acidic stream where a scale inhibiting composition is added to the acidic stream at any point from filtration onward in the acid production and evaporation processes.

2. The process of claim 1 wherein the scale inhibiting composition is additionally added at digestion.

3. The process of claim 1 wherein the scale inhibiting composition is additionally added to the acidic slurry.

4. The process of claim 1 wherein the scale inhibiting composition is added to the acidic stream during evaporation.

5. The process of claim 1 wherein the scale inhibiting composition is added to the acidic stream prior to entering the evaporation process.

6. The process of claim 1 wherein the ore is a phosphate containing ore.

7. The process of claim 6 wherein the acidic solution is sulfuric acid.

8. The process of claim 1 where the scale inhibiting composition is one or a combination of an organic phosphate, a phosphonate, an inorganic phosphate, a polycarboxylate homopolymer or copolymer.

9. The process of claim 1 where the scale inhibiting composition is added in substoichiometric amounts.

10. The process of claim 1 where the scale inhibiting composition is added from 0.1 to 5000 ppm.

11. The process of claim 1 where the scale inhibiting composition is added from 0.1 to 100 ppm.

12. The process of claim 1 where the scale inhibiting composition is added from 0.1 to 50 ppm.

13. The process of claim 1 where the scale inhibiting composition is added prior to the production of the acidic slurry.

14. A process for inhibiting the formation of scale in acid production wherein a phosphate containing ore is combined with an acidic solution for digestion and forms an acidic slurry where a scale inhibiting composition is added to the acidic slurry at any point through the filtration process.

15. The process of claim 14 wherein the scale inhibiting composition is added prior to digestion.

16. The process of claim 14 wherein the phosphate containing ore is beneficiated prior to being combined with the acidic solution.

17. The process of claim 14 wherein the acidic solution is sulfuric acid.

18. The process of claim 14 where the scale inhibiting composition is one or a combination of an organic phosphate, a phosphonate, an inorganic phosphate, a polycarboxylate homopolymer or copolymer.
